(19) United States
(12) Patent Application Publication
(10) Pub. No.: US 2019/0047462 A1
(43) Pub. Date: Feb. 14, 2019

(54) MODULAR CONFIGURABLE PLATFORM ARCHITECTURE FOR CA/AD VEHICLES

(71) Applicant: Intel Corporation, Santa Clara, CA (US)

(72) Inventors: Divya Vijayaraghavan, Los Altos, CA (US); Nageen Himayat, Fremont, CA (US); Florence Pon, Folsom, CA (US); Fatema Adenwala, Hillsboro, OR (US); Ankitha Chandran, Portland, OR (US)

(21) Appl. No.: 16/141,710

(22) Filed: Sep. 25, 2018

(51) Int. Cl. B60P 3/11; G05D 1/00; B64C 39/02

(52) U.S. Cl. CPC B60P 3/11; G05D 1/0088; B64C 39/024; A61G 3/00; B64C 2201/108; B64C 2201/027; B64C 2201/208

(57) ABSTRACT

In embodiments, a computer-assisted or autonomous driving (CA/AD) vehicle includes a docking platform to receive one or more unmanned aerial vehicles (UAVs) of different types to dock with the CA/AD vehicle, each UAV to include at least one sensor directed to a configurable specific use of the CA/AD vehicle, and a UAV interface to communicate with the one or more docked UAVs, including to receive sensor data obtained by the one or more UAVs. In embodiments, the CA/AD vehicle is configured to a specific use, based at least in part on the one or more UAVs docked with the CA/AD vehicle.

### FIELD

The present disclosure relates to the field of computer-assisted or autonomous driving (CA/AD). More particularly, the present disclosure relates to method and apparatus for a modular configurable platform architecture for CA/AD vehicles.

### BACKGROUND

There are many uses envisaged for CA/AD vehicles. Many of these uses are complex and, as a result, require specialized tools and sensors, as well as hardware and software platforms. For example, future ambulances may be specially configured CA/AD vehicles, requiring an interior supporting emergency and first aid equipment. Or, for example, future taxis or school buses may be CA/AD vehicles whose interior is adapted to serve the elderly, infants, children with special needs, etc. Such a specialized vehicle may need a sensing platform, tailored for its environment and its operational mode. The various adaptations and specializations that are needed for each specialized type of CA/AD vehicle require a significant investment for each CA/AD vehicle, which may be prohibitive.

### BRIEF DESCRIPTION OF THE DRAWINGS

FIG. 1 illustrates an overview of an environment for incorporating and using the configurable platform architecture of the present disclosure, in accordance with various embodiments.

FIG. 2 illustrates an example configurable modular CA/AD vehicle, in accordance with various embodiments.

FIG. 3 illustrates an example series of messages between an example service center, an example configurable CA/AD vehicle, and purpose built unmanned aerial vehicles (UAVs), in accordance with various embodiments.

FIG. 4 illustrates example ports provided in a CA/AD vehicle to connect to one or more hardware modules, in accordance with various embodiments.

FIG. 5 illustrates an example modular CA/AD vehicle originally configured for operation in a taxi mode that, in response to an emergency situation, is changed to operate in an ambulance mode, in accordance with various embodiments.

FIG. 6 illustrates an overview of the operational flow of a process for receiving a first type of assignment, operating in a first operational mode in accordance with the first assignment, and, in response to detection of an emergency condition, reconfiguring to operate in a second operational mode, in accordance with various embodiments.

FIG. 7 illustrates an overview of the operational flow of a process for a CA/AD vehicle receiving a specific use assignment, configuring for the assignment, and completing the assignment, in accordance with various embodiments.

FIG. 8 illustrates an example UAV, including one or more sensors, to dock on a docking platform provided at the CA/AD vehicle, in accordance with various embodiments.

FIG. 9 illustrates a software component view of the configurable platform management system, according to various embodiments.

FIG. 10 illustrates a hardware component view of the configurable platform management system, according to various embodiments.

FIG. 11 illustrates a storage medium having instructions for practicing embodiments of the processes of FIGS. 3, 5, 6 and 7.

### DETAILED DESCRIPTION

In embodiments, an apparatus for computer-assisted or autonomous driving (CA/AD) includes a docking platform, disposed at a CA/AD vehicle, to receive one or more unmanned aerial vehicles (UAVs) of different types to dock with the CA/AD vehicle, each UAV to include at least one sensor directed to a configurable specific use of the CA/AD vehicle, and a UAV interface, disposed at the CA/AD vehicle to communicate with the one or more docked UAVs, including to receive sensor data obtained by the one or more UAVs. In embodiments, the CA/AD vehicle is configured to a specific use, based at least in part on the one or more UAVs docked with the CA/AD vehicle.

In embodiments, a method of operating a dynamically reconfigurable CA/AD includes receiving, by the CA/AD vehicle, one or more UAVs of different types to be docked on the CA/AD, each UAV including one or more sensors directed to a configurable specific use of the CA/AD vehicle, and docking the one or more UAVs on a docking platform of the CA/AD vehicle. The method further includes connecting the CA/AD vehicle, via a UAV interface, to the one or more UAVs to obtain sensor data from each of the one or more UAVs one or more sensors, the sensor data used in operation of the CA/AD vehicle according to the configurable specific use.

In embodiments, a UAV to configure a computer-assisted or autonomous driving (CA/AD) vehicle includes one or more sensors directed to a configurable specific use of the CA/AD vehicle; and a docking mechanism to securely dock the UAV at the CA/AD vehicle. In embodiments, the CA/AD vehicle is configured to the specific use, based at least in part on the UAV docked with the CA/AD vehicle.

In embodiments, a system includes a set of UAVs, each UAV of the set including one or more sensors directed to a specific use of a dynamically reconfigurable CA/AD vehicle, and the dynamically reconfigurable CA/AD vehicle. The CA/AD vehicle includes a docking platform, to dock the set of UAVs so as to be configured for the specific use, and a UAV interface to communicate with the set of UAVs, including to receive sensor data obtained by each of the UAVs in the set. In embodiments, the specific use for which the CA/AD is configured is changed by replacing the set of docked UAVs with another.

In the description to follow, reference is made to the accompanying drawings which form a part hereof wherein like numerals (or, as the case may be, the last two digits of an index numeral) designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Also, it is noted that embodiments may be described as a process depicted as a flowchart, a flow diagram, a dataflow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in the figure(s). A process may correspond to a method, a function, a procedure, a subroutine, a subprogram, and the like. When a process corresponds to a function, its termination may correspond to a return of the function to the calling function and/or the main function. Furthermore, a process may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and the like.

As used hereinafter, including the claims, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may implement, or functions associated with the circuitry may be implemented by, one or more software or firmware modules.

As used hereinafter, including the claims, the term “memory” may represent one or more hardware devices for storing data, including random access memory (RAM), magnetic RAM, core memory, read only memory (ROM), magnetic disk storage mediums, optical storage mediums, flash memory devices and/or other machine readable mediums for storing data. The term “computer-readable medium” may include, but is not limited to, memory, portable or fixed storage devices, optical storage devices, wireless channels, and various other mediums capable of storing, containing or carrying instruction(s) and/or data.

As used hereinafter, including the claims, the term “computing platform” may be considered synonymous to, and may hereafter be occasionally referred to, as a computer device, computing device, client device or client, mobile, mobile unit, mobile terminal, mobile station, mobile user, mobile equipment, user equipment (UE), user terminal, machine-type communication (MTC) device, machine-to-machine (M2M) device, M2M equipment (M2ME), Internet of Things (IoT) device, subscriber, user, receiver, etc., and may describe any physical hardware device capable of sequentially and automatically carrying out a sequence of arithmetic or logical operations, equipped to record/store data on a machine readable medium, and transmit and receive data from one or more other devices in a communications network. Furthermore, the term “computing platform” may include any type of electronic device, such as a cellular phone or smartphone, a tablet personal computer, a wearable computing device, an autonomous sensor, personal digital assistants (PDAs), a laptop computer, a desktop personal computer, a video game console, a digital media player, an in-vehicle infotainment (IVI) and/or an in-car entertainment (ICE) device, an in-vehicle computing system, a navigation system, an autonomous driving system, a vehicle-to-vehicle (V2V) communication system, a vehicle-to-everything (V2X) communication system, a handheld messaging device, a personal data assistant, an electronic book reader, an augmented reality device, and/or any other like electronic device.

As used hereinafter, including the claims, the term “link” or “communications link” may refer to any transmission medium, either tangible or intangible, which is used to communicate data or a data stream. Additionally, the term “link” may be synonymous with and/or equivalent to “communications channel,” “data communications channel,” “transmission channel,” “data transmission channel,” “access channel,” “data access channel,” “channel,” “data link,” “radio link,” “carrier,” “radiofrequency carrier,” and/or any other like term denoting a pathway or medium through which data is communicated.

Given the many applications that a CA/AD vehicle may perform, in embodiments, a modular CA/AD vehicle is provided that is configurable for multiple applications, operational modes or tasks. For example, the CA/AD may be used as an “ambulance as a service” vehicle, requiring an interior that supports emergency and first aid equipment. Alternatively, for example, the CA/AD vehicle may be configured to operate as a regular or specialized taxi service, where the interior of the vehicle, as well as its operational hardware and software, are each adapted to transport the elderly, an infant, special needs children, or the like. Further, the CA/AD vehicle may be temporarily provided with various sensing platforms that are tailored for the vehicle's environment, or the task it is asked to perform, in a particular configuration. For example, multiple sensors may be used in bad weather conditions, or additional, redundant, or more precise sensors used in dense and/or hazardous environments. In embodiments, these temporary extensions of a basic sensor array are provided by UAVs that dock on the modular CA/AD vehicle, and then connect, via a UAV interface of the vehicle, to an on-board management system of the CA/AD vehicle.

In the article Cognitive Internet of Vehicles, in Computer Communications 120 (2018) 58-70, by Min Chen, et al., the authors posited the concept of CIoV (Cognitive Internet of Vehicles). CIoV presents a layered approach to architecting the various functions performed in a CA/AD vehicle. CIoV posits a stack that includes, beginning at the bottom, sensing, communication, cognition, control and application layers. In the view of the inventors hereof, in terms of the conceptual framework of CIoV, CA/AD vehicles need to dynamically adapt at each layer of the CIoV stack to effectively detect, and react to, changes in environment and driver status. However, this has been a pressing challenge for adopters of CIoV to date.

Thus, in embodiments, a modular configurable platform architecture is provided to address the pressing challenge of real-time adaptability in CA/AD vehicles. To swap defective sensors and hardware in real time, as well as to augment existing on-board sensors, and to remove sensor arrays no longer needed when an operative mode of the CA/AD vehicle is changed, UAV technology is utilized. In addition, FPGA technology is used in combination with one or more CPUs to dynamically swap workloads in and out, to adaptively prioritize workload acceleration.

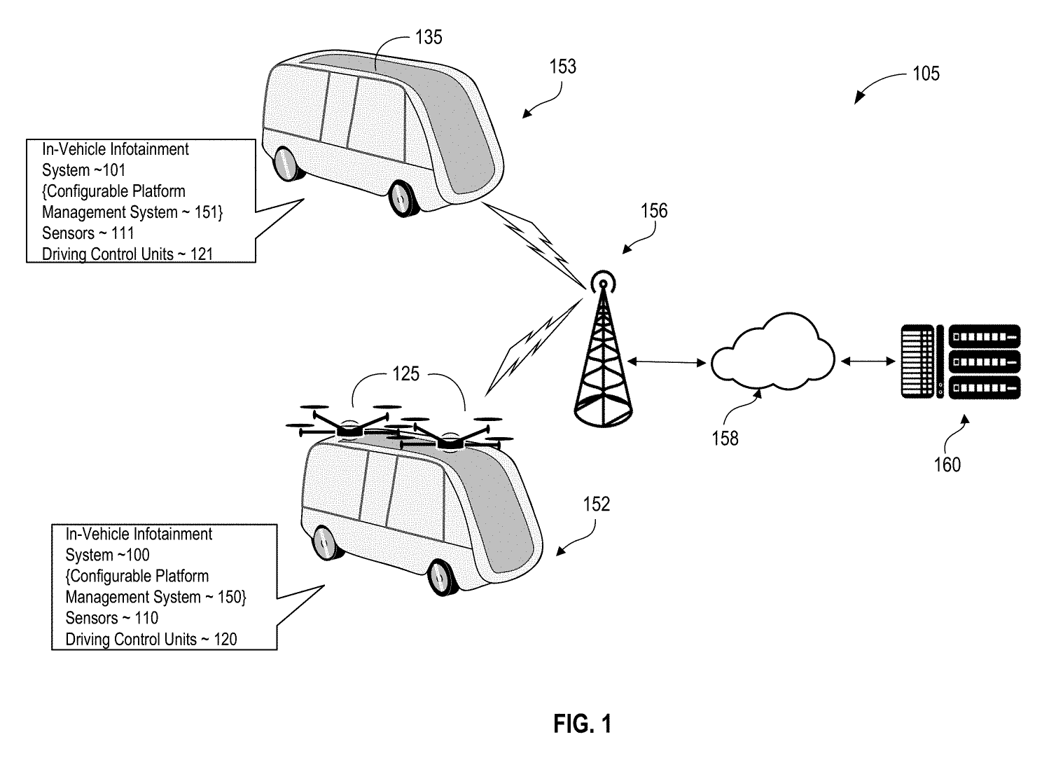

Referring now to FIG. 1, wherein an overview of an environment for incorporating and using the modular configurable CA/AD vehicle technology of the present disclosure, in accordance with various embodiments, is illustrated. As shown, example environment 105 includes modular vehicle 152 having an engine, transmission, axles, wheels and so forth. Further, vehicle 152 includes in-vehicle infotainment (IVI) system 100 having a number of infotainment subsystems/applications, e.g., instrument cluster subsystem/applications, front-seat infotainment subsystem/application, such as, a navigation subsystem/application, a media subsystem/application, a vehicle status subsystem/application and so forth, and a number of rear seat entertainment subsystems/applications.

Still further, vehicle 152 is provided with a configurable platform management system (CPM) 150 of the present disclosure, to provide vehicle 152 with computer-assisted or autonomous management, including to receive an operational assignment from a service center, to be configured or re-configured in response to such assignment, and to interact with one or more UAVs that are used to configure or re-configure it. Once configured, CPM system 150 is to monitor and manage the performance of the assignment, as described in detail below.

Environment 105 generally includes a plurality of CA/AD vehicles, and thus another example vehicle 153 is also shown, as a representative of other vehicles in environment 105. In actual embodiments, more or less vehicles may be used. Vehicle 153 is also equipped with in-vehicle system 101 having similar CPM system 151 of the present disclosure.

In some embodiments, CPM system 150/151 is further configured to individually assess one or more occupants' respective physical or emotional conditions, on determination that a possible emergency condition, such as a medical event, has occurred. Such a medical event may have occurred, for example, as a result of an accident or malfunction of vehicle 152/153, which CPM 150/151 determines. Alternatively, the medical event may be unrelated to a vehicle incident, and may be an acute condition of a passenger or driver, as the case may be. As described below, one configuration of vehicles 152/153 is to provide a taxi service, and that may include a specialized taxi service for elderly, special needs children, or the like, who are more likely to experience medical events while en-route. Each occupant being assessed may be a driver or a passenger of vehicle 152/153. For example, each occupant may be assessed to determine if the occupant's condition is critical and stressed, moderate and/or stressed, minor but stressed, minor and not stressed, or not ill, not injured and not stressed. In some embodiments, CPM system 150/151 is further configured to assess the vehicle's condition, on determination that the vehicle 152/153 is involved in a vehicle incident. For example, the vehicle may be assessed to determine that it is severely damaged and not operable, moderately damaged but not operable, moderately damaged but operable, or minor damages and operable. In some embodiments, CPM system 150/151 is further configured to assess condition of an area surrounding vehicle 152/153, on determination that vehicle 152/153 is involved in a vehicle incident. For example, the area surrounding vehicle 152/153 may be assessed to determine whether there is a safe shoulder area for vehicle 152/153 to safely move to, if vehicle 152/153 is operable, or if there is a convenient are nearby for a replacement vehicle, sent in response to a distress call by vehicle 152/153 to park and load passengers from vehicle 152/153.

Still referring to FIG. 1, vehicle 152 and vehicle 153 may each include sensors 110 and 111, and driving control units 120 and 121, respectively. In embodiments, sensors 110/111 are configured to provide various sensor data to CPM 150/151 to enable CPM to make navigational as well as operational decisions. In some embodiments, sensors 110/111 may include cameras (outward facing as well as inward facing), light detection and ranging (LiDAR) sensors, microphones, accelerometers, gyroscopes, inertia measurement units (IMU), engine sensors, drive train sensors, tire pressure sensors, docking platform pressure sensors, and so forth. Driving control units 120/121 may include electronic control units (ECUs) that control the operation of the engine, the transmission, the steering, and/or braking of vehicle 152/153. As described more fully below, sensors 110/111 may be augmented by additional, specialized or more accurate sensors provided in UAVs that land on, or in, vehicle 152/153.

In some embodiments, CPM system 150/151 is further configured to determine and/or recommend an occupant caring action or a vehicle action, based at least in part on the assessment(s) of the occupant(s) condition, the assessment of the vehicle's condition, the assessment of a surrounding area's condition, and the then current assignment the vehicle is on. In embodiments, CPM 150/151 may issue or cause to be issued, driving commands, to driving control units 120/121 to move vehicle 152/153 to effectuate or contribute to effectuating the occupant or vehicle care action, in light of the current assignment of the CA/AD vehicle. In some embodiments, the recommended occupant caring action, and/or vehicle action, may be overridden or modified by a driver or passenger of the vehicle.

Vehicles 152/153 also include a docking platform 135, as shown on vehicle 153, to allow one or more UAVs 125 to physically connect to the vehicles, in furtherance of the vehicle configuring itself for an operational mode appropriate for its then current assignment. Once docked, the UAVs connect over a UAV interface to the CPM system of vehicle 152/153. Vehicle 152 is shown with two UAVs docked on top of it, and vehicle 153 is shown with none. This illustrates an example situation where vehicle 152 is still performing a mission, and thus requires the associated set of UAVs 125 to provide additional sensing or connectivity capabilities, whereas vehicle 153 has completed a mission, and has sent its UAVs back to a service center, for reuse with another CA/AD vehicle. At the illustrated point in time, vehicle 153 has either not yet received a new assignment, or, for example, has received a new assignment, but has not yet received its set of UAVs to configure it for that new assignment.

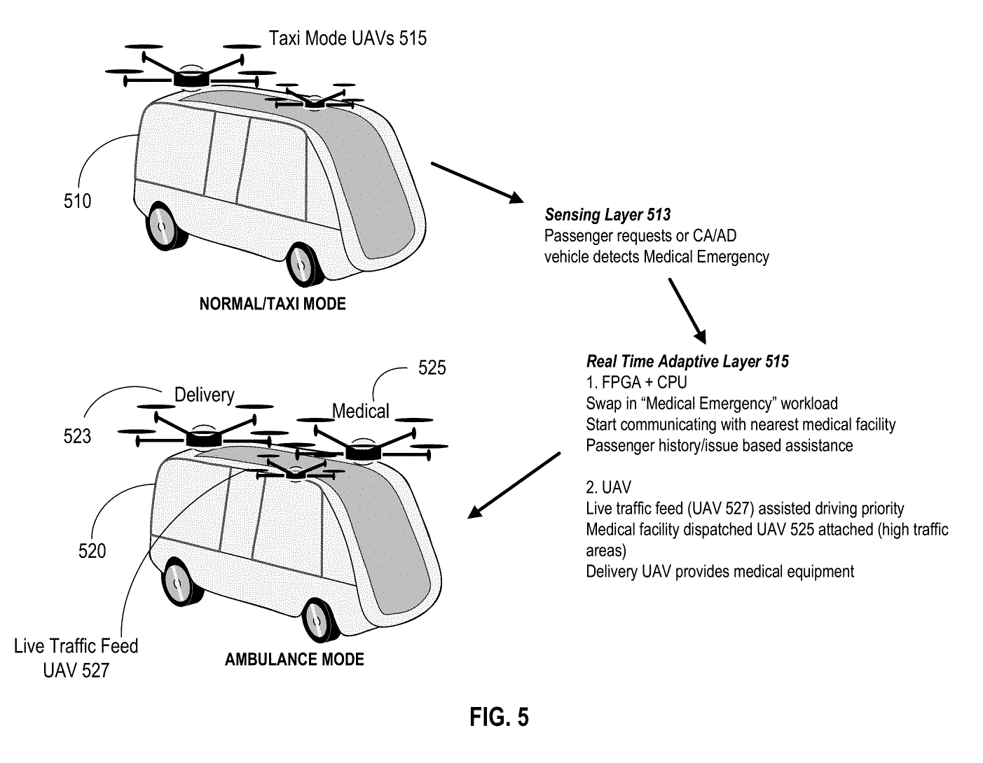

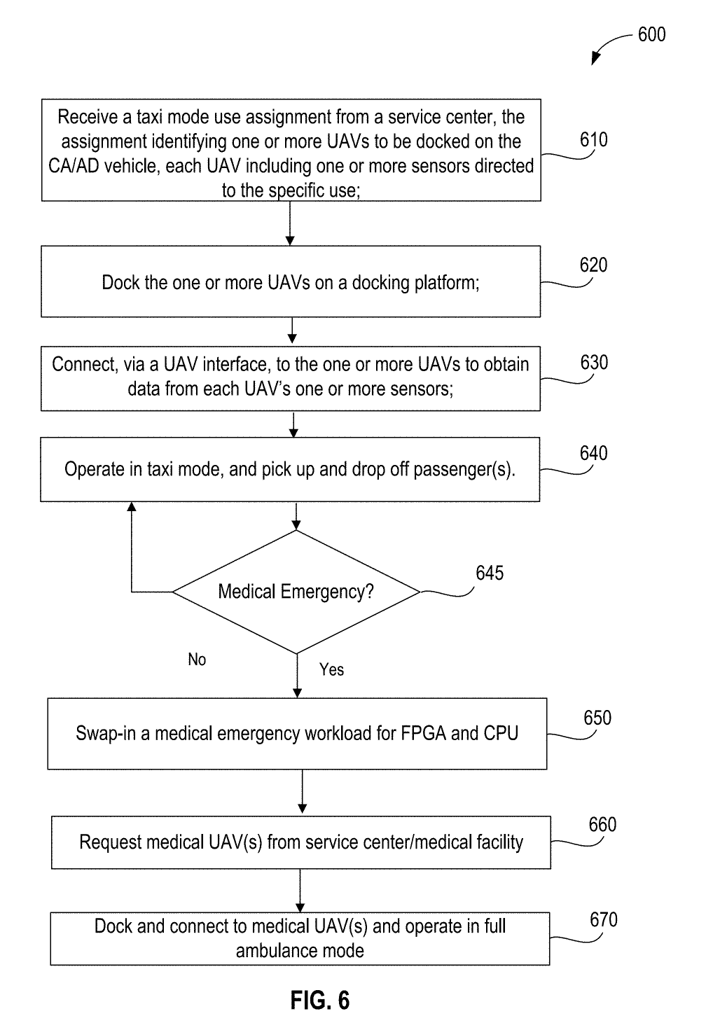

In some embodiments, CPM system 100, either on its own, or in response to user interactions, may communicate or interact with one or more off-vehicle remote content servers 160, via a wireless signal repeater or base station on transmission tower 156 near vehicle 152, and one or more private and/or public wired and/or wireless networks 158. Servers 160 may be servers associated with a service center that provides vehicles 152/153 with their various operational assignments, servers associated with law enforcement, servers associated with a customer of the service center, such as, for example, a client that hires one or more vehicles to perform night surveillance of a neighborhood or other property, or a server of a taxi service provider running a fleet of CA/AD vehicles on an as needed basis. Servers 160 may, alternatively, be servers of one or more medical centers when the vehicle is in an ambulance operational mode, or even when it is not, but in a situation when it must quickly reconfigure to operate in ambulance mode, in response to a medical emergency occurring to one of its passengers, as described in detail below in connection with FIGS. 5 and 6. Still alternatively, servers 160 may be third party servers who provide vehicle incident related services, such as forwarding reports/information to insurance companies, repair shops, and so forth, for storage and subsequent review by law enforcement, insurance adjusters and so forth. Examples of private and/or public wired and/or wireless networks 158 may include the Internet, the network of a cellular service provider, and so forth. It is to be understood that transmission tower 156 may be different towers at different times/locations, as vehicle 152/153 travels to a destination, or otherwise travels, as appropriate to its then prevailing operational mode.

These and other aspects of vehicles 152/153, and CPM system 150/151, will be further described with reference to the remaining figures.

As noted above, in embodiments, a CA/AD vehicle is combined with mobile UAVs which allow the vehicle be configured for a given assignment. In embodiments, the UAVs also allow the vehicle to be physically modified, to take on different shapes, or purposes with different capabilities, without requiring a return to a service center facility. In embodiments, the vehicle provides a charging or docking platform for different types of UAVs which, as noted, once docked on the platform and connected to the CA/AD vehicle, allow the vehicle to take on different personalities. For example a given UAV may provide a “dynamic LIDAR” sensor, allowing the vehicle to operate in autonomous mode on city streets. Or, for example, a UAV may provide emergency surgical equipment that is needed for an emergency response use case, or operation in ambulance mode.

In embodiments, a CA/AD vehicle with a modular platform is further supported by adapting software for use specific hardware, or a particular service configuration. In accordance with various embodiments, a flexible, dynamically extensible CA/AD service platform is adaptable to various use cases with built in fault-tolerance capabilities. In embodiments, the CA/AD vehicle is provided with hardware and software components which can dynamically adapt to changing workloads.

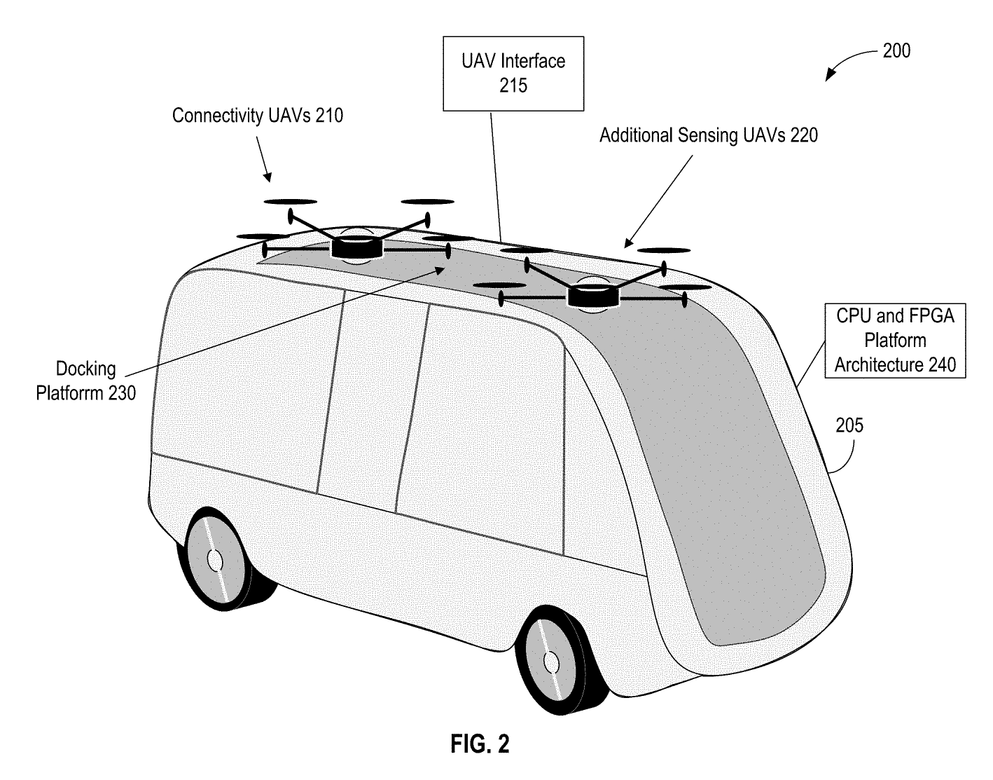

FIG. 2 illustrates an example modular CA/CD vehicle, supplemented by UAV support, in accordance with various embodiments. With reference to FIG. 2, there is shown CA/AD vehicle 205, with two types of UAVs docked on the top of the CA/AD vehicle. The UAVs are docked on docking platform 230. Docking platform 230 includes charging strips (not shown), to keep any UAVs that may be docked on it charged. Although only two UAVs are shown in FIG. 2, in embodiments there may be more or less UAVs docked on a given CA/AD vehicle at any given time. The two UAVs shown are representative of two general types of UAV which may dock to a CA/AD vehicle in various embodiments. Although not shown in the example of FIG. 2, in alternate embodiments UAVs may also dock inside the CA/AD vehicle, such as, for example, when the UAV is a third type of UAV, one that delivers one or more objects or devices to the CA/AD vehicle as part of configuring it for a specialized use. For example the hardware items may include a single edge contact cartridge (SECC) module, to be inserted into a port on the interior of the CA/AD, or the delivered object may be a set of medical equipment, to be provisioned inside the CA/AD when it is configured to operate as an ambulance.

In embodiments, as shown, example UAVs may be connectivity UAVs 210, and additional sensing UAVs 220. In embodiments, connectivity UAVs 210 provide additional connectivity to a CA/AD vehicle when its assignment so requires, such as, for example, a satellite communications connection when the CA/AD vehicle is operating in an area with low cellular network coverage. Or, for example, if the CA/AD vehicle is provisioned to connect to one network, and another cellular network has entered the market with better connectivity, a UAV may dock to the vehicle to provide connectivity to that additional cellular network. Additional sensing UAVs provide additional sensors, not generally provided in the base platform of the modular CA/AD vehicle. These sensors may include, for example, for a night sensing operational mode, such as may be part of a security services assignment, infrared and other night vision sensors and cameras. Or, for example, for an autonomous driving operational mode, the sensors provided by a UAV may include high precision positioning sensors, such as LIDAR, or millimeter wave (MM-wave) positioning devices. In embodiments, all UAVs docked on, or in, CA/AD vehicle 205 are linked, via UAV interface 215, to the vehicle's CPU and FPGA platform architecture, which may run an example CPM system application, as described above.

Although not shown in FIG. 2, in embodiments, the interior of the CA/AD vehicle is also customizable for each envisaged service or corresponding operational mode. It is noted that while an exemplary CA/AD vehicle is obviously capable of driving to a service location for servicing or adapting of its platform, in embodiments, UAV assistance allows for updates and reconfiguration where the CA/AD vehicle is disabled, or where congestion or traffic does not allow the CA/AD vehicle to receive service in a timely fashion. Alternatively, where sophisticated UAVs are used to add connectivity, sensor array as well as to deliver needed equipment, it is often not at all necessary to “bring the CA/AD vehicle home” (e.g., to the service center) that often, if it is operating properly and can simply be reconfigured several successive times in the field. In embodiments, UAV assistance also allows for sharing the same hardware across many applications and address dynamically variable demand.

In embodiments, a configurable central processing unit and field programmable gate array (CPU and FPGA) platform architecture is also provided in the CA/AD vehicle. This is indicated by CPU and FPGA platform architecture 240, generally pointing to the interior of vehicle 205, where it is located. In embodiments, configurable platform architecture 240 allows for implementation of the CIoV model referred to above with real-time adaptability of workloads. In embodiments, for example, partial reconfiguration regions in an FPGA are dedicated to specific CIoV layers, enabling dynamic swapping in and out of layer-specific workloads. In embodiments, this enables for simultaneous processing of the CIoV sensing, communication, cognition, control and application layers. Moreover, in embodiments, the CPM system running in vehicle 205 may be adaptively tuned to inline processing by utilizing more memory bandwidth, more networking I/O capability, weighted arbitration to select the number and bandwidth of I/O links such as PCIe and UPI connecting the CPU and FPGA, and image acquisition on the FPGA. Additionally, in embodiments, the system may be adaptively tuned to lookaside processing utilizing weighted arbitration between CPU-to-FPGA connectivity links to reduce latency associated with CPU-to-FPGA data transfers.

In embodiments, the modular architecture of the CA/CD vehicle allows for periodic upgrading of workloads during the life of the CA/CD vehicle. It further supports adaptive workload swapping to respond to traffic (or other) scenarios that may require a particular application to be prioritized in real-time. For example, for operational modes where a driver is present, processing the driver's healthcare record in response to an emergency.

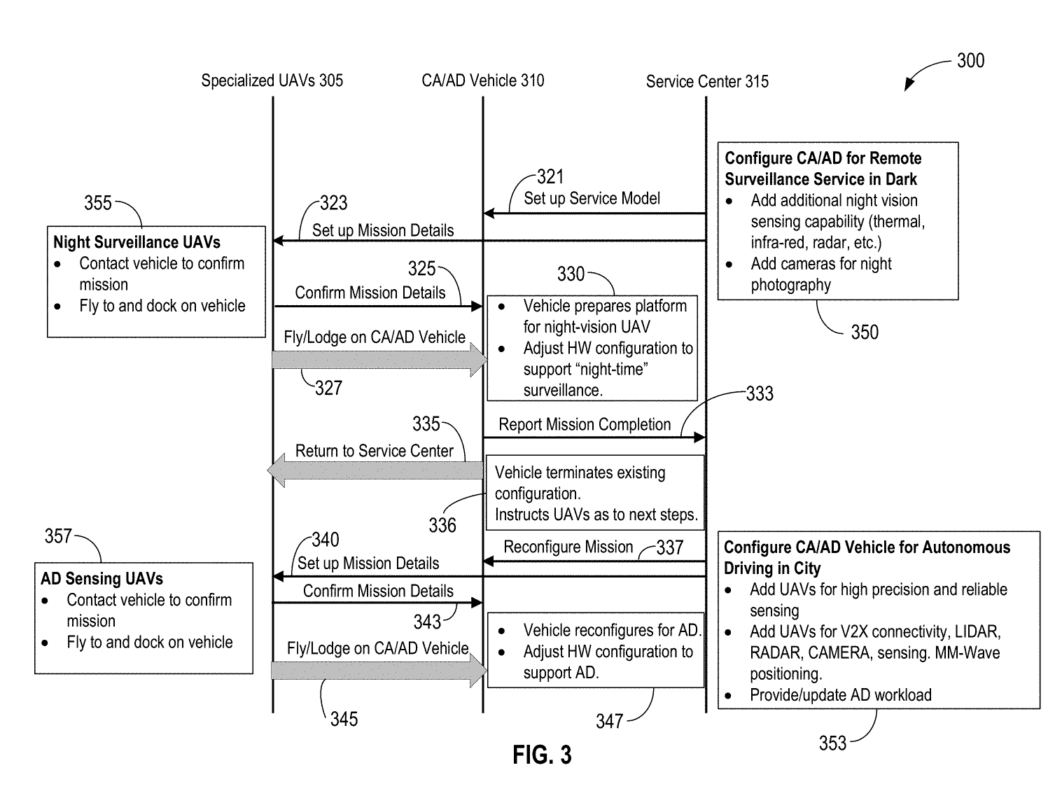

FIG. 3 illustrates an example series of messages between an example service center, an example configurable CA/AD vehicle, and specialized UAVs, in accordance with various embodiments. FIG. 3 also illustrates flights taken by the specialized UAVs, in response to some of the messages (shown in thicker, grey colored arrows 327, 335 and 345). In the example of FIG. 3, a reconfigurable CA/AD vehicle is reconfigured to switch from a first night-time surveillance mission to a second mission: autonomous driving in a busy city. In the example of FIG. 3, the different sensing capabilities required by the CA/AD vehicle for these two use cases are adjusted, by replacing a first set of UAVs on the CA/AD vehicle with a second set of UAVs that has different sensing capabilities.

With reference to FIG. 3, as shown at 350, the initial mission for the CA/AD vehicle is nighttime surveillance. Service center 315 directs that the CA/AD vehicle be configured by adding additional night vision sensing capability, as shown at 350, as well as adding night photography cameras to the CA/AD vehicle. The mission may be, for example, performed by a routine residential neighborhood security service, or, for example, it may be performed by an autonomous vehicle operated for the police, military or a private security firm, guarding a high value asset or target. To initiate the process, service center 315 sends message 321 to CA/AD vehicle 310 directing it to set up the service model. Additionally, at approximately the same time, message 323 is sent from service center 315 to specialized UAVs 305 to set up mission details. In response, the UAVs, in this case night surveillance UAVs 355, contact vehicle 310 to confirm the mission details, and fly to the vehicle and dock on it. Upon receipt of message 323, specialized UAVs 305 send message 325 to vehicle 310 confirming the mission details, and then as shown by travel arrow 327, fly to, and dock on, vehicle 310. As noted with reference to FIG. 2, in embodiments, a docking platform on CA/AD vehicle 310 has charging strips, so the UAVs are kept fully charged while docked.

Continuing with reference to FIG. 3, at block 330, in response to the arrival of UAVs 305, CA/AD vehicle 310 prepares its sensing platform for night-vision UAVs 355, and adjusts its hardware configuration to support nighttime surveillance. In embodiments, this may involve switching the FPGA to load a new workload. When the nighttime surveillance mission has terminated, CA/AD vehicle 310 sends message 333 to service center 315 advising service center 315 that the mission has been completed.

In addition, as shown at block 336, CA/AD vehicle 310 terminates its existing configuration (e.g., “night surveillance”), and, having no more need for a night sensing sensor array, it instructs the UAVs 355 as to next steps. This latter message is not shown in FIG. 3, as it is sent across an internal UAV interface between, for example, the CA/AD vehicle's CPM system running on the vehicle's CPU, and the connected UAVs, as described above in connection with FIG. 2. In response to the instruction from CA/AD vehicle 310, night surveillance UAVs 355 return to service center 350, as shown by travel arrow 335.

Continuing with reference to FIG. 3, at block 353, service center 315 directs that the CA/AD vehicle be configured for autonomous driving (AD) in a city. This includes adding UAVs for high precision and reliable sensing, adding UAVs for V2X connectivity, adding Lidar, Radar, and Cameras, and sensors for MM-wave positioning. Additionally, this requires using an existing or newly updated AD workload. To initiate the process, service center 315 sends message 337 to CA/AD vehicle 310 directing it to reconfigure its mission. Additionally, at approximately the same time, message 340 is sent from service center 315 to specialized UAVs 305 to set up mission details. In response, the UAVs, in this case AD sensing UAVs 357, contact vehicle 310 to confirm the mission details, and fly to the vehicle and dock on it, as shown at block 357. Thus, upon receipt of message 343, AD sensing UAVs 357 send message 343 to vehicle 310 confirming the mission details, and then, as shown by travel arrow 345, fly to, and dock on, vehicle 310. As noted with reference to FIG. 2, in embodiments, a docking platform on CA/AD vehicle 310 has charging strips, so the UAVs are kept fully charged while docked.

In response to the arrival of AD sensing UAVs 357, as shown at block 347, CA/AD vehicle 310 reconfigures for AD, and adjusts its hardware configuration to support AD. In embodiments, this may involve switching the FPGA to load a new workload.

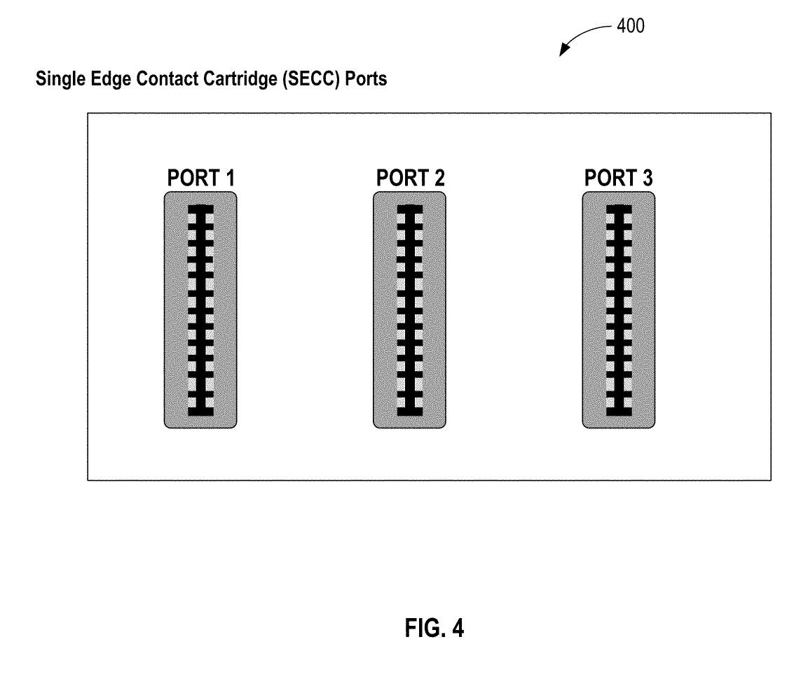

FIG. 4 illustrates example ports 400 provided in a CA/AD vehicle to connect to one or more hardware modules, in accordance with various embodiments. In embodiments, the one or more hardware modules may be delivered by one or more UAVs temporally docked with the CA/AD vehicle to configure the CA/AD vehicle to a specific use. In embodiments, Single Edge Contact Cartridges (SECC), for example, may be used to implement modularity. By inserting an SECC module into one of SECC ports (slots) 400, a module appropriate for the then current operational mode (mission) of an exemplary CA/AD vehicle may be utilized by the CA/AD vehicle. Table 1 below illustrates an example port assignment for each of three ports 400, where each port receives a control module directed to a different functionality, either environmental control (Port 1), communications (Port 2) or computation (Port 3).

TABLE 1

| Port | | | | Performance |
|---|---|---|---|---|
| No. | Function | Custom Taxi | Ambulance | Driving |
| 1 | Environmental | Special | Life support | Extreme |
| | control | lighting, air | | weather and |
| | | temperature | | physical |
| | | controls, | | road (or |
| | | intelligent | | off-road) |
| | | seating | | conditions |
| 2 | Communications | Remote visual | For remote | Interaction |
| | | confirmation | emergency | with myriad |
| | | of passengers, | M.D. | of sensors |
| | | remote door | assistance | needed for |
| | | operations for | | driving |
| | | passenger | | feedback |
| | | safety | | controls |
| 3 | Computation | Remote vehicle | Life support | Extreme |
| | | operation work- | workloads | condition |
| | | loads | | workloads |

Referring to Table 1, the functionality that each port of Ports 1-3 in FIG. 4 respectively addresses, is provided in column 2. Columns 3-5 of Table 1 are each addressed to one operational mode, or specialized use, of an example CA/CD vehicle, and for each of the ports listed in column 1 and described in column 2 of Table 1, the appropriate functionality provided by a SECC module inserted in the respective port is described. Thus, with reference to column 3, for a custom taxi use, the environmental control (Port 1) provided by an example SECC module provides specialized lighting, air temperature controls, and intelligent seating, e.g., determining if a passenger is in, or no longer in, his or her seat. For Port 2, communications, for the custom taxi specialized use, an example SECC module provides, for example, remote visual confirmation of passengers, and remote door operations for passenger safety. Finally, for Port 3, computation, in embodiments, an example SECC module provides remote vehicle operation workloads. In each of columns 4 and 5, Table 1 describes similar functionalities that example SECC modules may provide, in embodiments, for the ambulance and performance driving respective operational modes, or specialized uses, of an example CA/AD vehicle according to various embodiments.

It is noted that, in embodiments, the use of self-contained SECC modules, or the like, to implement modularity also benefits from various beneficial features of SECC modules, which include independently operated thermal solutions, and electromagnetic interference (EMI) containment. In embodiments, SECC modules allow a CA/AD vehicle to easily swap the proper hardware, software, and workloads needed to upgrade the systems rather than expensive purpose built systems. In some embodiments, a human worker may be on board the CA/AD vehicle, and that worker may insert the appropriate SECC modules into ports 400 when configuring or reconfiguring the vehicle. Such workers may, in embodiments, be part of the service provided, and not involved in driving the vehicle, which may likely be fully computer driven. For example, in ambulance mode, or specialized taxi mode, it is contemplated that paramedics and attendants, respectively, are on hand in the interior of the CA/AD vehicle to assist patients and customers, respectively. In other embodiments, where there are no humans in the CA/AD vehicle, such as in a nighttime surveillance mission, one or more robotic arms, remotely guided by a service center operator, may be provided within the CA/AD vehicle to unplug and plug SECC modules into an appropriate port, as needed. In some embodiments, SECC modules that are commonly used by the CA/AD vehicle may be kept on board even when not in use, and repeatedly switched in and out, as needed. In other embodiments, if a reconfiguration is instructed by the service center for a specialized use that is relatively rare for the CA/AD vehicle, a delivery drone may bring the needed SECC modules to the CA/AD vehicle, and may even land on an interior docking platform, deliver the modules, and then fly away. A human worker, or, for example, the one or more tele-operational robotic arms described above, may then insert the appropriate SECC modules into the requisite ports. Of course, still alternatively, a CA/AD vehicle may be called back to the service center for reconfiguration.

Additional types of service models with different UAV capabilities are also possible. In some embodiments, service UAVs may be used for redundancy or as replacements in the event of an actual or a predicted failure. Also, as noted above, in embodiments, UAVs with different communications capabilities may be deployed to a CA/AD vehicle, if the wireless connectivity available in a given service area or geographical location is different than its then current hardware or docked UAVs can handle. Moreover, if, for example, it is raining, or the car is operating in extreme temperature zones, UAVs with equipment suited for the extreme weather may be used. Thus, in embodiments, UAVs as described in the examples above may augment, or even replace, the “normal” set of UAVs commonly used in a given configuration, where special circumstances require. An example of this is a CA/CD vehicle configured for ambulance service where an extreme snowstorm is expected, or has arrived, making all “normal” routes the ambulance service uses now hazardous, with different network connectivity, and where additional sensor arrays are need for safe driving, or the like.

In embodiments, delivery UAVs may be used, such as, for example, when the mission is to deliver packages to a given remote service area. In such embodiments, instead of flying a UAV to a remote area, an example CA/AD vehicle is loaded with the packages for delivery and the UAVs used for the last hop. In such embodiments, the CA/AD vehicle either parks in, or drives through, a neighborhood, and the UAVs on board deliver their packages to buildings or houses nearby. Essentially a shipping company with UAVs instead of driver/delivery men. In such example embodiments, the CA/AD vehicle is reconfigured to allow for storing packages as well as with new software to manage systematic package delivery (e.g., track all UAVs, queue delivery tasks, send alerts to package recipients, etc.).

FIG. 5 illustrates an example of a reconfiguration process of a modular configurable CA/AD vehicle, in accordance with various embodiments. In the example of FIG. 5, a modular CA/AD vehicle originally configured for operation in a taxi mode. However, in response to an emergency situation with a taxi passenger, the vehicle is reconfigured on the fly (and in the field) to operate in ambulance mode, in accordance with various embodiments. Although in the particular example of FIG. 5, the reconfiguration is performed in response to an emergency condition, in general, this is not necessarily the case.

With reference to FIG. 5, CA/AD vehicle 510 has been configured, and is operating, in a taxi mode. As part of its taxi assignment, taxi mode UAVs 151 have docked on a docking platform on the roof of vehicle 510. Taxi mode UAVs 510 may include, for example, UAVs provided with high precision positioning sensors, such as LIDAR, or millimeter wave (MM-wave) positioning devices, for example, as well as wireless interfaces to cloud servers that provide real-time dynamic route guidance based on up to the minute traffic and obstacle data.

At 513, it is assumed that one or more passengers has experienced a medical emergency, and that the “sensing layer”, to use the CIoV categories, of the CA/AD vehicle has detected the emergency, either by passenger request, interior camera, erratic movement of the affected passenger as detected by smart seating sensor arrays, or the like. In response to the medical emergency, the CA/AD vehicle is reconfigured on an urgent basis. This is reflected in FIG. 5 at 515 by actions taken at the CIoV “real time adaptive layer” of the CA/AD vehicles CPM system. The response includes two example tasks, involving each of FPGA+CPU and UAV functionality. In a first example task, the FPGA and CPU swap in a medical emergency workload. As noted above, this may be accomplished by adding an FPGA, or, for example, by loading a module already available in memory, or, for example, by replacing a set of SECC hardware modules directed to “custom taxi” with new ones directed to “ambulance”, as provided in Table 1, and as described above. Additionally, for example, the CPM, running on the CPU, opens communication with the nearest medical facility, and advises that an emergent patient is being routed to it. To the extent possible, medical records are accessed regarding the individual, to be used in any on-board treatment efforts en route. If the CA/AD vehicle was operating in taxi mode with no human attendant, in embodiments a paramedic may be picked up along the way to the medical facility to manage the patient en route. For example, the service center may route another CA/AD vehicle currently operating in ambulance mode, but with no patients on board, to rendez-vous with vehicle 510, so that a paramedic or other health care professional can board vehicle 510.

In a second example task, the taxi mode UAVs are sent back to service center, and new UAVs, to configure CA/AD vehicle 510 to operate in ambulance mode, are sent. These UAVs may include, for example, medical facility dispatched UAV 525, with navigational sensors designed to guide emergency vehicles in high traffic areas, and a live traffic feed UAV 527, to provide connectivity to a live traffic feed server to augment CA driving of the vehicle. Additionally, for example, delivery UAV 523 may, in embodiments, deliver medical equipment, pharmaceuticals, or other items needed to manage the patient while en-route to the medical center. In embodiments, both delivery UAV 523 and medical UAV 525 may be based at the medical center, and may fly to the vehicle (now vehicle 520) to achieve the rapid reconfiguration to ambulance mode. In such embodiments, medical UAV may send real-time medical information, including vital signs, EKG results, or the like, in a direct feed to the medical center, so that emergency room (ER) personnel at the medical center are already knowledgeable about the patient's case when he or she arrives at the ER of the medical center. Once all of the reconfiguration has been accomplished, as shown at 520, the CA/AD vehicle is operating in ambulance mode.

Referring now to FIG. 6, an overview of the operational flow of a process 600 for receiving a first type of assignment, operating in a first operational mode in accordance with the first assignment, and, in response to detection of an emergency condition, reconfiguring to operate in a second operational mode, in accordance with various embodiments, is presented. Process 600 uses the example first operational mode and second operational modes illustrated in FIG. 5, and described above, for ease of illustration. Process 600 may be performed by a CA/AD vehicle such as vehicles 152 or 153 of FIG. 1, or vehicle 205 of FIG. 2, for example. Or, for example, more precisely, process 600 may be performed by CA/AD vehicle 510 and 520 (which is the same vehicle in two operational modes), as shown in FIG. 5. Process 600 may include blocks 610 through 660. In alternate embodiments, process 600 may have more or less operations, and some of the operations may be performed in different order.

Process 600 begins at block 610, where the CA/AD vehicle receives a taxi mode assignment from a service center. The assignment identifies one or more UAVs that the CA/AD vehicle is to expect, that are to be docked on the vehicle. In the depicted example, each UAV includes one or more sensors directed to the specific use, here a taxi service. Thus, for example, the UAVs may provide precision positioning sensors, accurate in high density urban cores.

From block 610, process 600 proceeds to block 620, where the one or more UAVs to help configure the CA/AD vehicle for taxi mode operation are docked on the vehicle's docking platform. From block 620, process 600 proceeds to block 630, where the CA/AD vehicle, for example, via a CPM system as described above, connects via a UAV interface to the one or more UAVs now docked on the docking platform.

From block 630, process 600 proceeds to block 640, where, the CA/AD vehicle now fully configured for it, operates in taxi mode, and, as such, picks up and drops off passengers. From block 640, process 600 moves to query block 645, where CA/AD vehicle determines if a passenger is undergoing a medical emergency. If “No” at query block 645, then process 600 returns to block 640, and continues to operate in taxi mode. Thus, in embodiments, blocks 640 and 645 may constitute a continuous loop for any CA/AD vehicle operating in a taxi mode, school bus mode, etc., where there is a risk of a passenger possibly having a medical emergency. This illustrates one of the significant benefits of the modular configurable CA/AD vehicle according to various embodiments. There are often related operational modes, where a given vehicle may start out configured for one, and ends up not infrequently re-configuring to the other. Thus, the re-configuration can be statistically expected to occur, and preparations for a quick and efficient re-configuration built into the system, such as, for example, by regularly stocking SECC hardware modules and FPGAs for both operational modes in the vehicle, and developing efficient UAV replacement protocols when a change is to occur. One such protocol may be, in embodiments, to have taxi mode UAVs and ambulance UAVs available at one or more satellite service centers, nearby the routes the taxi service CA/AD vehicles normally travel, such as in a city center or core business area, or, as described above, provided in UAV “hangars” at local trauma centers, where, once operating in ambulance mode, are the main CA/AD vehicle's destinations.

Continuing with reference to FIG. 6, if the return at query block 645 was a “Yes”, then process 600 moves to block 650, where it begins being reconfigured for an ambulance operational mode. Thus, a medical emergency workload for the FPGA and CPU is loaded or installed, as the case may be. Once installed and loaded, the medical workload, for example, determines a nearest medical center, and begins communications with it, as shown, for example, at 515 of FIG. 5, described above. From block 650 process 600 moves to block 660, where the CA/AD vehicle requests the medical center to send one or more medical UAVs to be sent to it for docking, to configure the vehicle both to operate in ambulance mode in general, and to prepare the patient and the medical center for the patient's arrival at the designated medical center in particular.

For example, the medical UAVs, once docked at the vehicle, may send real-time medical information, including vital signs, EKG results, or the like, in a direct feed to the medical center, so that emergency room (ER) personnel at the medical center are already knowledgeable about the patient's case when he or she arrives at the ER of the medical center, and his or her records may be accessed. Additionally, the medical UAVs may, in embodiments, deliver medical equipment, pharmaceuticals, or other items needed to manage the patient, according to the medical center's specific protocols, while en-route to the medical center. Still additionally, for example, a medical UAV may, accessing an interior camera on the CA/AD vehicle, send a live feed of the patient to the medical center's ER, so that trauma physicians may begin working on the case even before the patient arrives. In alternate embodiments, the medical UAVs may be sent not from the medical center, but form the service center.

From block 660 process 600 moves to block 670, where the medical UAVs are docked, connected to the CA/AD vehicle's CPM via a UAV interface, and the CA/AD vehicle operates in full ambulance mode.

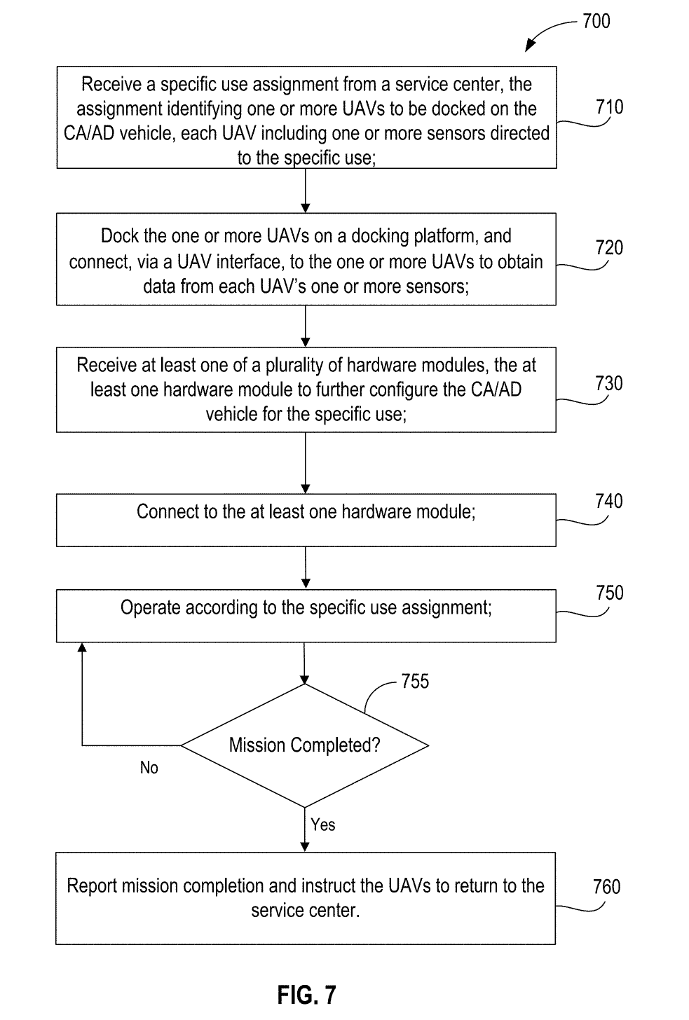

Referring now to FIG. 7, an overview of the operational flow of a process 700 for receiving a specific use assignment, being configured for the assignment, and completing the assignment, is shown. Process 700 may be performed by a CA/CD vehicle such as vehicles 152 or 153 of FIG. 1, or vehicle 205 of FIG. 2, for example. Process 700 may include blocks 710 through 760. In alternate embodiments, process 700 may have more or less operations, and some of the operations may be performed in different order.

Process 700 begins at block 710, where the CA/AD vehicle receives a specific use assignment from a service center. The assignment identifies one or more UAVs to be docked on the CA/AD vehicle, each of which includes one or more sensors directed to the specific use.

From block 710, process 700 proceeds to block 720, where the one or more UAVs to help configure the CA/AD vehicle for the specific use are docked on the vehicle's docking platform, and connect, via a UAV interface, to the CA/AD vehicle so that the vehicle obtains data form each of the UAVs one or more sensors. From block 720, process 700 proceeds to block 730, where the CA/AD vehicle receives at least one of a plurality of hardware modules, to further configure the CA/AD vehicle for the specific use. For example, the hardware modules may be SECC modules, or the like, that may be plugged into ports inside the CA/AD vehicle, as described above in connection with FIG. 4 and Table 1.

From block 730 process 700 moves to block 740, where the vehicle connects to the at least one hardware module. For example, and as noted above, in some embodiments, a human worker may be on board the CA/AD vehicle, and that worker may insert the appropriate hardware modules into appropriate ports. Such workers may, in embodiments, be part of the service provided, and not involved in driving the vehicle, which may likely be fully computer driven. For example, in ambulance mode, or specialized taxi mode, it is contemplated that paramedics and attendants, respectively, are on hand in the interior of the CA/AD vehicle to assist patients and customers, respectively. In other embodiments, where there are no humans in the CA/AD vehicle, such as where the specific use is nighttime surveillance, one or more robotic arms, for example remotely guided by a service center operator, may be provided within the CA/AD vehicle to unplug and plug hardware modules into an appropriate port, as needed. In some embodiments, the hardware modules that are commonly used by the CA/AD vehicle may be kept on board even when not in use, and repeatedly switched in and out, as needed. In other embodiments, if a reconfiguration is instructed by the service center for a specialized use that is relatively rare for the CA/AD vehicle, a delivery drone may bring the necessary hardware modules to the CA/AD vehicle, and may even land on an interior docking platform, deliver the modules, and then fly away. A human worker, or, for example, the one or more tele-operational robotic arms described above, may then connect the hardware modules to the CA/AD vehicle. Of course, still alternatively, a CA/AD vehicle may be called back to the service center for reconfiguration.

From block 750, process 700 moves to query block 755, where it is determined whether the mission of the CA/AD vehicle, in this particular operational mode, has been completed. In embodiments, this determination may be made in a variety of ways. In one example, the specific use assignment may direct a clearly defined objective, that, once completed, ends the mission, such as daybreak ends operation in night surveillance mode, for example. In other examples the CA/AD vehicle may report each time a task in line with the overall specific use is completed, such as each completed trip in taxi or ambulance mode, and may receive a response to either continue, continue for a defined number of additional trips, or stop operations. Or, in yet another example, where a CA/AD vehicle itself triggered a reconfiguration due to an emergency, as illustrated in FIGS. 5 and 6, once the patient has been delivered to the nearby medical center, the protocol may be that operation in the reconfigured mode immediately ceases, and the vehicle returns to its original operational mode, which has its own mission completion criteria.

If the return at query block 755 was a “Yes”, then process 700 moves to block 760, where it reports mission completion to the service center and instructs the docked UAVs to return to the service center, which may be a satellite service center functioning as a local “UAV hangar”, as described above.

However, if the return at query block 755 was a “No”, then process 700 returns to block 750, and continues to operate according to the specific use assignment.

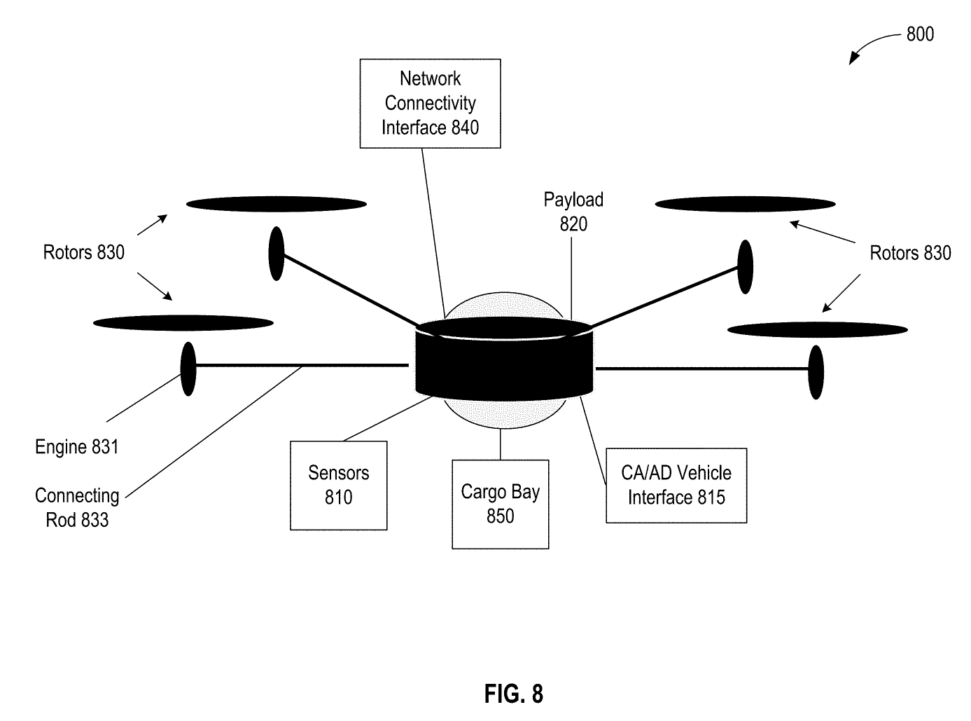

FIG. 8 illustrates an example UAV 800, including one or more sensors, to dock on a docking platform provided at the CA/AD vehicle, in accordance with various embodiments. With reference thereto, example UAV 800 includes payload 820 and rotors 830. In the example of FIG. 8, UAV has four rotors. In alternate embodiments, more or less rotors may be used. Each of rotors 830 includes an engine 831 (shown only for one rotor). Each engine is attached to the central payload 820 by a connecting rod 833 (shown only for one rotor). In embodiments, payload 820 is provided with one or more sensors 810, the one or more sensors to add functionality to a CA/AD vehicle, and thereby configure it for a special use. UAV 800, in embodiments, further includes a CA/AD vehicle interface 815, through which, once docked on an example CA/AD vehicle, data from on-board sensors 810 is accessed by the CA/AD vehicle, including by various software programs and applications running on its CPU and FPGA platform, as described above.

In some embodiments, UAV 800 provides additional connectivity to a CA/AD vehicle at which it is docked, when the CA/AD vehicle's assignment so requires, such as, for example, a satellite communications connection when the CA/AD vehicle is operating in an area with low cellular network coverage. Or, for example, if the CA/AD vehicle is provisioned to connect to one network, and another cellular network has entered the market with better connectivity, a UAV 800 may dock to the vehicle to provide connectivity to that additional cellular network.

In embodiments, sensors 810 include additional sensors, not generally provided in the base platform of a modular CA/AD vehicle. These sensors may include, for example, for a night sensing operational mode, such as may be part of a security services assignment, infrared and other night vision sensors and cameras. Or, for example, for an autonomous driving specific use the sensors provided in UAV 800 may include high precision positioning sensors, such as LIDAR, or millimeter wave (MM-wave) positioning devices.

In embodiments, UAV 800 includes a cargo bay 850, to hold various items to be delivered to either a CA/AD vehicle on which UAV 800 temporarily docks, or, in an automated delivery service specific use, where the UAV delivers packages to persons by flying from a docking platform of the CA/AD vehicle to a customer's residence or business location. In embodiments, items to be transported in cargo bay 850, and then delivered to a CA/AD vehicle, may include one or more hardware modules to configure the CA/AD vehicle to a specific use, such as several SEC modules, as described above. Or, in embodiments, items to be delivered to a CA/AD vehicle may include tools and other implements to be used while operating according to a specific use, such as medical equipment, drugs, intravenous apparatus and fluids, and the like, for when the CA/AD vehicle's specific use is that of an ambulance service.

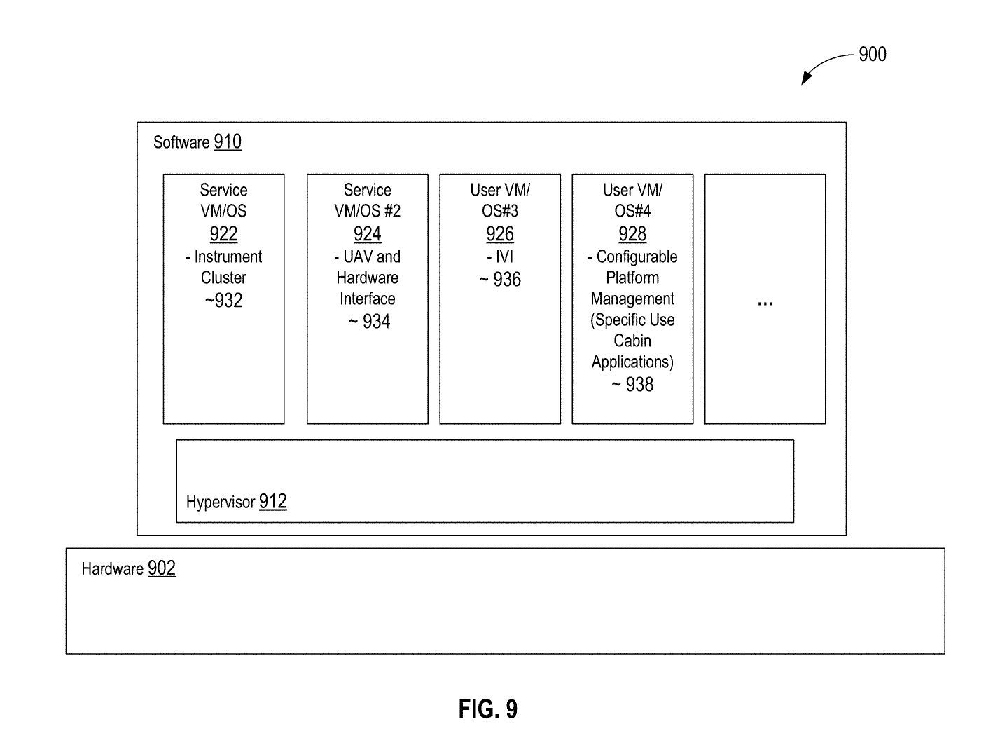

Referring now to FIG. 9, wherein a software component view of the CPM system, according to various embodiments, is illustrated. As shown, for the embodiments, CPM system 900, which could be CPM system 100, includes hardware 902 and software 910. Software 910 includes hypervisor 912 hosting a number of virtual machines (VMs) 922-928. Hypervisor 912 is configured to host execution of VMs 922-928. The VMs 922-928 include two service VMs 922 and 924, and a number of user VMs 926-928. Service machine 922 includes a service OS hosting execution of a number of instrument cluster applications 932. Service machine 924 includes a second service OS hosting execution of UAV interface applications and hardware module interface applications. User VMs 926-928 may include a first user VM 926 having a first user OS hosting execution of in-vehicle infotainment applications 936, and a second user VM 928 having a second user OS hosting execution of a configurable platform management system, including cabin applications related to the then current specific use of the CA/AD vehicle 938, and so forth.

Except for the CPM technology 150, 151 of the present disclosure incorporated, elements 912-938 of software 910 may be any one of a number of these elements known in the art. For example, hypervisor 912 may be any one of a number of hypervisors known in the art, such as KVM, an open source hypervisor, Xen, available from Citrix Inc, of Fort Lauderdale, Fla., or VMware, available from VMware Inc of Palo Alto, Calif., and so forth. Similarly, service OS of service VMs 922-924, and user OS of user VMs 926-928 may be any one of a number of OS known in the art, such as Linux, available e.g., from Red Hat Enterprise of Raleigh, N.C., or Android, available from Google of Mountain View, Calif.

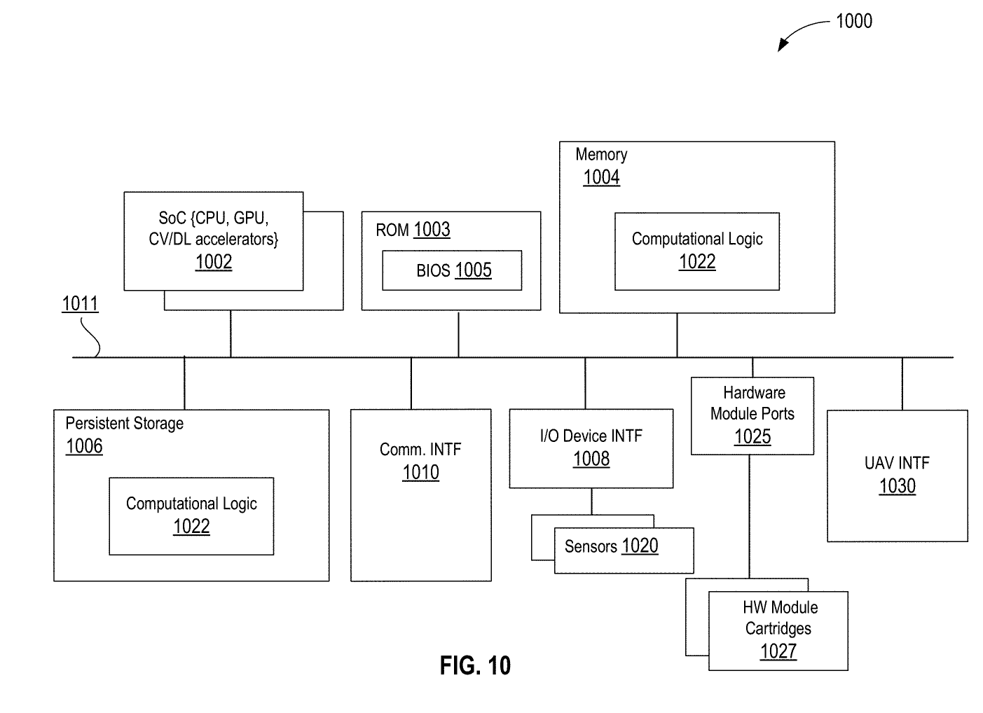

Referring now to FIG. 10, wherein an example computing platform that may be suitable for use to practice the present disclosure, according to various embodiments, is illustrated. As shown, computing platform 1000, which may be hardware 1002 of FIG. 10, may include one or more system-on-chips (SoCs) 1002, ROM 1003 and system memory 1004. Each SoCs 1002 may include one or more processor cores (CPUs), one or more graphics processor units (GPUs), one or more accelerators, such as computer vision (CV) and/or deep learning (DL) accelerators. ROM 1003 may include basic input/output system services (BIOS) 1005. CPUs, GPUs, and CV/DL accelerators may be any one of a number of these elements known in the art. Similarly, ROM 1003 and BIOS 1005 may be any one of a number of ROM and BIOS known in the art, and system memory 1004 may be any one of a number of volatile storage known in the art.

Additionally, computing platform 1000 may include persistent storage devices 1006. Example of persistent storage devices 1006 may include, but are not limited to, flash drives, hard drives, compact disc read-only memory (CD-ROM) and so forth. Further, computing platform 1000 may include input/output device interface 1008 (such as, to couple to display, keyboard, cursor control and so forth) and communication interface 1010 (such as, to couple to network interface cards, modems and so forth). I/O device interface 1008 may further include any number of I/O devices known in the art, such as, for example, sensors 1020. Examples of communication devices that may be connected to communications interface 1010 may include, but are not limited to, networking interfaces for Bluetooth®, Near Field Communication (NFC), WiFi, Cellular communication (such as LTE 4G/5G) and so forth. The elements may be coupled to each other via system bus 1011, which may represent one or more buses. In the case of multiple buses, they may be bridged by one or more bus bridges (not shown).

Each of these elements may perform its conventional functions known in the art. In particular, ROM 1003 may include BIOS 1005 having a boot loader. System memory 1004 and persistent storage 1006 may be employed to store a working copy and a permanent copy of the programming instructions implementing the operations associated with hypervisor 112, service/user OS of service/user VM 1022-1028, and components of CPM technology 150 (such as UAV interface 215, CA/AD vehicle 205, docking platform 230, modular hardware modules connected via SECC ports 400, or the like, and so forth), collectively referred to as computational logic 1022. The various elements may be implemented by assembler instructions supported by processor core(s) of SoCs 1002 or high-level languages, such as, for example, C, that can be compiled into such instructions.

In addition, computing platform 1000 may include hardware module ports 1025, such as, for example, SECC ports, into which one or more hardware module cartridges 1027 are inserted, to provide modularity. For example, hardware module cartridges 1027 may be SEC cartridges. To interface with one or more UAVs that may be docked on, or in, a CA/AD vehicle in which computing platform 1000 is provided, computing platform 1000 may also include UAV interface 1030.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

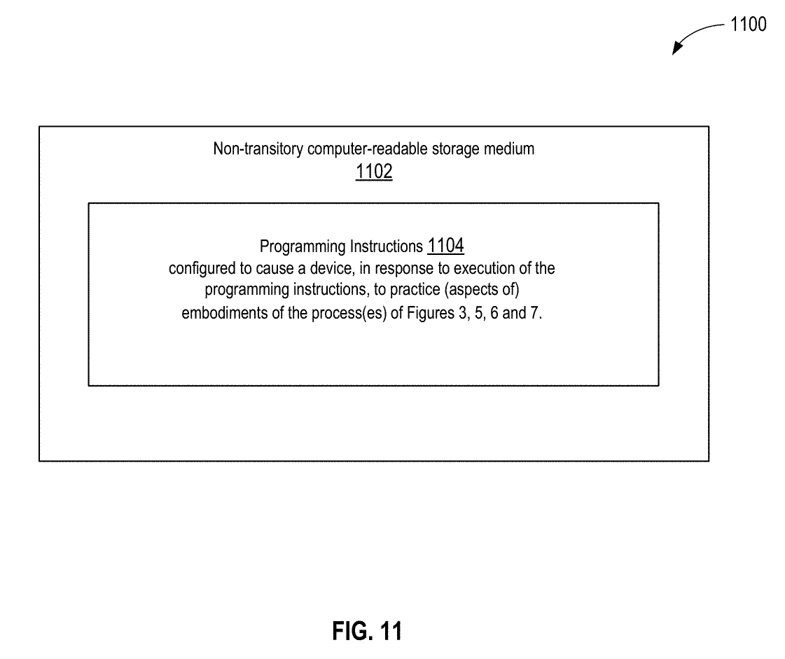

FIG. 11 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1102 may include a number of programming instructions 1104. Programming instructions 1104 may be configured to enable a device, e.g., computing platform 1000, in response to execution of the programming instructions, to implement (aspects of) hypervisor 112, service/user OS of service/user VM 122-128, and selected functionalities of components of CPM technology 150 (such as UAV interface 215, CA/AD vehicle 205, docking platform 230, modular hardware modules connected via SECC ports 400, or the like, and so forth). In alternate embodiments, programming instructions 1104 may be disposed on multiple computer-readable non-transitory storage media 1102 instead. In still other embodiments, programming instructions 1104 may be disposed on computer-readable transitory storage media 1102, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

### Examples

Example 1 is a computer-assisted or autonomous driving (CA/AD) vehicle comprising a docking platform to receive one or more unmanned aerial vehicles (UAVs) of different types to dock with the CA/AD vehicle, each UAV to include at least one sensor directed to a configurable specific use of the CA/AD vehicle, and a UAV interface to communicate with the one or more docked UAVs, including to receive sensor data obtained by the one or more UAVs. The CA/AD vehicle is configured to a specific use, based at least in part on the one or more UAVs docked with the CA/AD vehicle.

Example 2 is the apparatus of example 1, further comprising a core vehicle platform common to all uses for which the CA/AD vehicle may be configured.

Example 3 is the apparatus of example 1, further comprising a hardware module interface, disposed at the CA/AD vehicle, to connect to at least one of a plurality of hardware modules, to further configure the CA/AD vehicle for the specific use.

Example 4 is the apparatus of example 3, wherein the hardware module interface includes at least one port to receive the one hardware module having a single edge contact cartridge (SECC) form factor.

Example 5 is the apparatus of example 3, wherein the hardware module interface includes a plurality of ports, each to connect to circuitry of the hardware module that provides a pre-defined type of control.

Example 6 is the apparatus of example 5, wherein the pre-defined type of control is one of: environmental control, communications control, or computational control.

Example 7 is the apparatus of example 1, wherein the docking platform is further to receive one or more delivery UAVs to be used to deliver packages from the CA/AD vehicle to a customer.

Example 8 is the apparatus of example 7, further comprising a hardware module interface, disposed at the CA/AD vehicle, to connect to at least one of a plurality of hardware modules, to further configure the CA/AD vehicle for a specific use of package delivery.

Example 9 is the apparatus of example 1, wherein the docking platform is further to receive one or more delivery UAVs to deliver additional vehicle parts or equipment to the CA/AD vehicle needed for the specific use.

Example 10 is the apparatus of example 9, further comprising a robotic arm to grasp the additional vehicle parts or equipment and either provide them in, or install them on, the CA/AD vehicle.

Example 11 is the apparatus of example 1, wherein the specific use is one of night surveillance service, taxi service, remote package delivery service or ambulance service.

Example 12 is the apparatus of example 1, further comprising a transceiver, to receive a specific use assignment from a service center and confirm its receipt.

Example 13 is the apparatus of example 12, wherein the specific use assignment includes an identification of the one or more UAVs to be docked on the docking platform.

Example 14 is the apparatus of example 1, wherein the specific use to which the CA/AD vehicle is configured is changed while the CA/AD vehicle is in motion.

Example 15 is a UAV to configure a computer-assisted or autonomous driving (CA/AD) vehicle, comprising: one or more sensors directed to a configurable specific use of the CA/AD vehicle; and a docking mechanism to securely dock the UAV at the CA/AD vehicle; wherein the CA/AD vehicle is configured to the specific use, based at least in part on the UAV docked with the CA/AD vehicle.

Example 1 is the UAV of example 15, further comprising a CA/AD vehicle interface to communicate with the CA/AD vehicle, including to transmit sensor data obtained by the UAV.

Example 17 is the UAV of example 15, wherein the UAV is a delivery UAV to provide parts or equipment to the CA/AD vehicle for the specific use.

Example 18 is the UAV of example 15, wherein either: the specific use is night sensing, and the one or more sensors include at least one of: infrared sensor, night vision sensor, night vision camera; or the specific use is autonomous driving, and the one or more sensors include at least one of: a high precision positioning sensor, LIDAR, or a millimeter wave (MM-wave) positioning device.

Example 19 is a method of operating a dynamically reconfigurable CA/AD vehicle, comprising: receiving, by the CA/AD vehicle, one or more UAVs of different types to be docked on the CA/AD vehicle, each UAV including one or more sensors directed to a configurable specific use of the CA/AD vehicle; docking the one or more UAVs on a docking platform of the CA/AD vehicle; and connecting the CA/AD vehicle, via a UAV interface of the CA/AD vehicle, to the one or more UAVs to obtain sensor data from each of the one or more UAVs one or more sensors, the sensor data being used in operation of the CA/AD vehicle according to the configurable specific use.

Example 20 is the method of example 19, further comprising: connecting, via a hardware module interface disposed at the CA/AD vehicle, the interface including one or more ports, to at least one of a plurality of hardware modules inserted into a port of the interface, the at least one hardware module to further configure the CA/AD for the specific use.

Example 21 is the method of example 19, wherein receiving one or more UAVs of different types includes receiving one or more delivery UAVs to provide parts or equipment needed for the specific use.

Example 22 is the method of example 19, wherein the specific use to which the CA/AD vehicle is configured is changed while the CA/AD vehicle is in motion.

Example 23 is the method of example 22, wherein either: the specific use is night sensing, and the one or more sensors include at least one of: infrared sensor, night vision sensor, night vision camera; or the specific use is autonomous driving, and the one or more sensors include at least one of: a high precision positioning sensor, LIDAR, or a millimeter wave (MM-wave) positioning device.

Example 24 is a system, comprising: a set of UAVs, each UAV of the set including one or more sensors directed to a specific use of a dynamically reconfigurable computer-assisted or autonomous driving (CA/AD) vehicle; and the dynamically reconfigurable CA/AD vehicle, comprising: a docking platform, to dock the set of UAVs with the CA/AD vehicle and thereby having the CA/AD vehicle be configured for the specific use; and a UAV interface to communicate with the set of UAVs, including to receive sensor data obtained by each of the UAVs in the set, wherein the specific use for which the CA/AD is configured is changed by replacing the set of docked UAVs with another.

Example 25 is the system of example 24, the CA/AD vehicle further comprising a modular vehicle platform that is common to all of the specific uses for which the CA/AD may be configured.

Example 26 is the system of example 24, wherein the CA/AD vehicle further comprises a hardware module interface, to connect to at least one of a plurality of hardware modules, that, when connected, further configure the CA/AD vehicle for the specific use.

Example 27 is the system of example 24, wherein the docking platform is arranged to dock the set of UAVs while the CA/AD vehicle is in motion.

Example 28 is an apparatus, comprising: means for receiving one or more UAVs of different types to be docked on a CA/AD vehicle, each UAV including one or more sensors directed to a configurable specific use of the CA/AD vehicle; means for docking the one or more UAVs on a docking platform of the CA/AD vehicle; and means for connecting the CA/AD vehicle, via a UAV interface of the CA/AD vehicle, to the one or more UAVs to obtain sensor data from each of the one or more UAVs one or more sensors, the sensor data being used in operation of the CA/AD vehicle according to the configurable specific use.

Example 29 is the apparatus of example 28, further comprising: means for connecting, via a hardware module interface means disposed at the CA/AD vehicle, the interface means including one or more ports, to at least one of a plurality of hardware modules inserted into a port of the interface means, the at least one hardware module to further configure the CA/AD for the specific use.

Example 30 is the apparatus of example 28, wherein the means for receiving includes means for receiving the one or more delivery UAVs to provide parts or equipment needed for the specific use.

Example 31 is the apparatus of example 28, wherein either: the specific use is night sensing, and the one or more sensors include at least one of: infrared sensor, night vision sensor, night vision camera; or the specific use is autonomous driving, and the one or more sensors include at least one of: a high precision positioning sensor, LIDAR, or a millimeter wave (MM-wave) positioning device.

What is claimed is:

1. An apparatus for computer-assisted or autonomous driving (CA/AD), comprising:
a docking platform, disposed at a CA/AD vehicle, to receive one or more unmanned aerial vehicles (UAVs) of different types to dock with the CA/AD vehicle, each UAV to include at least one sensor directed to a configurable specific use of the CA/AD vehicle; and
a UAV interface, disposed at the CA/AD vehicle, to communicate with the one or more docked UAVs, including to receive sensor data obtained by the one or more UAVs,
wherein the CA/AD vehicle is configured to a specific use, based at least in part on the one or more UAVs docked with the CA/AD vehicle.

2. The apparatus of claim 1, further comprising a core vehicle platform common to all uses for which the CA/AD vehicle may be configured.

3. The apparatus of claim 1, further comprising a hardware module interface, disposed at the CA/AD vehicle, to connect to at least one of a plurality of hardware modules, to further configure the CA/AD vehicle for the specific use.

4. The apparatus of claim 3, wherein the hardware module interface includes at least one port to receive the one hardware module having a single edge contact cartridge (SECC) form factor.

5. The apparatus of claim 3, wherein the hardware module interface includes a plurality of ports, each to connect to circuitry of the hardware module that provides a pre-defined type of control.

6. The apparatus of claim 5, wherein the pre-defined type of control is one of: environmental control, communications control, or computational control.

7. The apparatus of claim 1, wherein the docking platform is further to receive one or more delivery UAVs to be used to deliver packages from the CA/AD vehicle to a customer.

8. The apparatus of claim 7, further comprising a hardware module interface, disposed at the CA/AD vehicle, to connect to at least one of a plurality of hardware modules, to further configure the CA/AD vehicle for a specific use of package delivery.

9. The apparatus of claim 1, wherein the docking platform is further to receive one or more delivery UAVs to deliver additional vehicle parts or equipment to the CA/AD vehicle needed for the specific use.

10. The apparatus of claim 9, further comprising a robotic arm to grasp the additional vehicle parts or equipment and either provide them in, or install them on, the CA/AD vehicle.

11. The apparatus of claim 1, wherein the specific use is one of night surveillance service, taxi service, remote package delivery service or ambulance service.

12. The apparatus of claim 1, further comprising a transceiver, to receive a specific use assignment from a service center and confirm its receipt.

13. The apparatus of claim 12, wherein the specific use assignment includes an identification of the one or more UAVs to be docked on the docking platform.

14. The apparatus of claim 1, wherein the specific use to which the CA/AD vehicle is configured is changed while the CA/AD vehicle is in motion.

15. A UAV to configure a computer-assisted or autonomous driving (CA/AD) vehicle, comprising:
one or more sensors directed to a configurable specific use of the CA/AD vehicle; and
a docking mechanism to securely dock the UAV at the CA/AD vehicle;
wherein the CA/AD vehicle is configured to the specific use, based at least in part on the UAV docked with the CA/AD vehicle.

16. The UAV of claim 15, further comprising a CA/AD vehicle interface to communicate with the CA/AD vehicle, including to transmit sensor data obtained by the UAV.

17. The UAV of claim 15, wherein the UAV is a delivery UAV to provide parts or equipment to the CA/AD vehicle for the specific use.

18. The UAV of claim 15, wherein either:
the specific use is night sensing, and the one or more sensors include at least one of: infrared sensor, night vision sensor, night vision camera; or
the specific use is autonomous driving, and the one or more sensors include at least one of: a high precision positioning sensor, LIDAR, or a millimeter wave (MM-wave) positioning device.

19. A method of operating a dynamically reconfigurable CA/AD vehicle, comprising:
receiving, by the CA/AD vehicle, one or more UAVs of different types to be docked on the CA/AD vehicle, each UAV including one or more sensors directed to a configurable specific use of the CA/AD vehicle;
docking the one or more UAVs on a docking platform of the CA/AD vehicle; and
connecting the CA/AD vehicle, via a UAV interface of the CA/AD vehicle, to the one or more UAVs to obtain sensor data from each of the one or more UAVs one or more sensors, the sensor data being used in operation of the CA/AD vehicle according to the configurable specific use.

20. The method of claim 19, further comprising:
connecting, via a hardware module interface disposed at the CA/AD vehicle, the interface including one or more ports, to at least one of a plurality of hardware modules inserted into a port of the interface, the at least one hardware module to further configure the CA/AD for the specific use.

21. The method of claim 19, wherein receiving one or more UAVs of different types includes receiving one or more delivery UAVs to provide parts or equipment needed for the specific use.

22. A system, comprising:
a set of UAVs, each UAV of the set including one or more sensors directed to a specific use of a dynamically reconfigurable computer-assisted or autonomous driving (CA/AD) vehicle; and
the dynamically reconfigurable CA/AD vehicle, comprising:
a docking platform, to dock the set of UAVs with the CA/AD vehicle and thereby having the CA/AD vehicle be configured for the specific use; and
a UAV interface to communicate with the set of UAVs, including to receive sensor data obtained by each of the UAVs in the set,
wherein the specific use for which the CA/AD is configured is changed by replacing the set of docked UAVs with another.

23. The system of claim 22, the CA/AD vehicle further comprising a modular vehicle platform that is common to all of the specific uses for which the CA/AD may be configured.

24. The system of claim 22, wherein the CA/AD vehicle further comprises a hardware module interface, to connect to at least one of a plurality of hardware modules, that, when connected, further configure the CA/AD vehicle for the specific use.

25. The system of claim 21, wherein the docking platform is arranged to dock the set of UAVs while the CA/AD vehicle is in motion.
